(19) United States
(12) Patent Application Publication
(10) Pub. No.: US 2006/0237976 A1
(43) Pub. Date: Oct. 26, 2006

(54) Crushable structure manufactured from mechanical expansion

(75) Inventors: Scott C. Glasgow, Spring Lake, MI (US); David W. Heatherington, Spring Lake, MI (US); Bruce W. Lyons, Grand Haven, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Shape Corporation

(21) Appl. No.: 11/110,618

(22) Filed: Apr. 20, 2005

(51) Int. Cl. B60R 19/26

(52) U.S. Cl. 293/132

(57) ABSTRACT

A crush member for a vehicle having frame rails comprising a tube having a first end configured to be connected to the frame rails of the vehicle and a second end configured to be connected to a bumper. The tube has a constant thickness from the first end to the second end. The tube further has a taper along a axial direction from the first end to the second end, the tube having a larger cross section at the first end and a smaller cross section at the second end. The tube is configured to crush to absorb impact energy upon an axial or near axial load.

### FIELD OF THE INVENTION

The present invention relates to a beam design that absorbs energy efficiently while deforming. Applications for this invention could include vehicle bumper systems, side impact bars, and sill plates.

### BACKGROUND OF THE INVENTION

Various components on the front and rear of a vehicle are designed to crush upon axial or near axial loading. The crushing of these components absorbs impact energy associated with collisions. Absorption of the impact energy helps to reduce vehicle damage and protect occupants within the vehicle from bodily harm.

Heretofore, the components included bumper brackets 10 and frame rail ends 12 (FIG. 1). Bumper brackets 10 have typically been made from two separate stampings 14 that are welded together to form a tubular design (see FIG. 2). The tubular design of the bumper brackets 10 can taper from one end to the other end, thereby providing additional bending stiffness for off axis loading (e.g., near axial loading) yet provides for telescoping collapse via material of the bumper brackets 10 folding upon axial loading. The frame rail ends 12 are typically one-piece tubular in design that form a closed geometry or an open channel design. Crush initiators are commonly added to bumper brackets 10 and frame rail ends 12 in an attempt to obtain predictable crush and axial stability during the loading and subsequent crushing of the components. Common crush initiation features include darts, ribs and holes.

Energy absorbed during collision can be represented graphically as the area under a curve defined by impact force and simultaneous intrusion of the colliding vehicle or object into the struck vehicle. This type of curve is commonly referred to as a force vs. deflection curve (an “F-d curve”). Typical F-d curves produce a near linear relationship of increasing force and increasing intrusion. The efficiency at which a component absorbs energy is defined as the measured energy (area 16 under the F-d curve) divided by the energy associated with a box whose ordinate magnitude is defined by the maximum force 18 and abscissa 19 is defined by the maximum deflection of the event (see FIG. 3). Crush initiators can reduce the overall component efficiency due to the erratic F-d behavior associated with the crush initiator. A crush initiator will typically initiate crush. A drawback to crush initiators is that the load following the onset of initiation is lower than the load necessary to initiate the crush. This causes a peak and valley type of response where each valley represents a loss in efficiency due to a loss in load. The ideal response curve would be a component that maintains the initiation load over the distance of the crush. The goal in energy management components is to improve efficiency to levels that are 85% or higher in efficiency.

The development of highly efficient energy management components must also consider cost, ability to manufacture and component weight. With a vast array of possible manufacturing processes and materials, emphasis needs to be directed toward tooling investment, piece price and component weight. There exists materials and manufacturing processes that in tandem can be used to produce highly efficient energy management components, but all too often the cost of the product will limit its commercial acceptance and usage.

Accordingly, an apparatus is desired having the aforementioned advantages and solving and/or making improvements on the aforementioned disadvantages.

### SUMMARY OF THE PRESENT INVENTION

An aspect of the present invention is to provide a crush member for a vehicle having frame rails comprising a tube having a first end configured to be connected to the frame rails of the vehicle and a second end configured to be connected to a bumper. The tube has a polygonal cross section. The tube also has a constant thickness from the first end to the second end. The tube further has a taper along an axial direction from the first end to the second end, the tube having a larger cross section at the first end and a smaller cross section at the second end. The tube is configured to crush to absorb impact energy upon an axial or near axial load.

Another aspect of the present invention is to provide a bumper system for a vehicle comprising a frame rail, a crush member and a bumper. The frame rail extends along a longitudinal direction of the vehicle. The crush member is connected to a front end of the frame rail, with the crush member comprising a tube having a first end connected to the frame rail and a second end opposite the first end. The tube has a polygonal cross section. The tube also has a constant thickness from the first end to the second end. The tube further has a taper along an axial direction from the first end to the second end, with the tube having a larger cross section at the first end and a smaller cross section at the second end. The bumper is connected to the second end of the tube. The tube is configured to crush to absorb impact energy upon an axial or near axial load applied to the bumper.

Yet another aspect of the present invention is to provide a method of making a crush member for a vehicle having frame rails comprising forming material into a cylinder and expanding the cylinder into a tube having at least a portion with a constant thickness from a first end of the portion to a second end of the portion and to have a taper along an axial direction from the first end to the second end, with the tube having a larger cross section at the first end and a smaller cross section at the second end.

These and other aspects, objects, and features of the present invention will be understood and appreciated by those skilled in the art upon studying the following specification, claims, and appended drawings.

### BRIEF DESCRIPTION OF DRAWINGS

FIG. 1 is a top view of a prior art bumper system.

FIG. 2 is a perspective view of a prior art bumper bracket.

FIG. 3 is a load versus displacement graph of the prior art bumper system.

FIG. 4 is a top view of a bumper system of the present invention.

FIG. 5 is a perspective view of a crush member of the bumper beam of the present invention.

FIG. 6 is an inverted front view of the crush member of the bumper beam of the present invention.

FIG. 7 is a perspective view of a first mandrel used in forming the crush member of the bumper system of the present invention.

FIG. 8 is a perspective view of a second mandrel used in forming the crush member of the bumper system of the present invention.

FIG. 9 is a schematic view of a method of forming the crush member of the present invention.

FIG. 10 is a perspective view of a crush member of a second embodiment of the present invention.

FIG. 11 is a perspective view of a crush member of a third embodiment of the present invention.

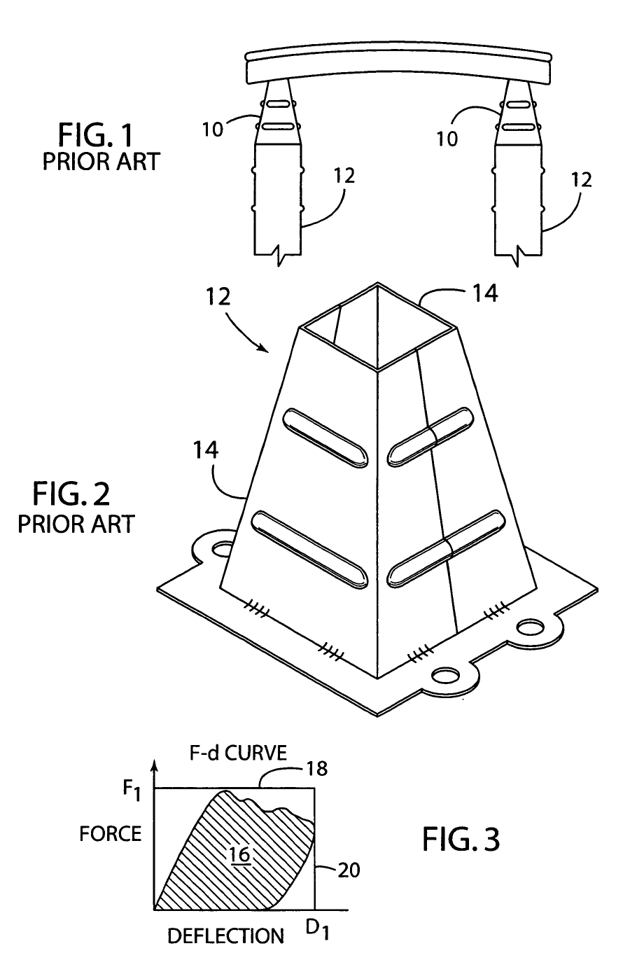

### DETAILED DESCRIPTION OF PREFERRED EMBODIMENTS

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

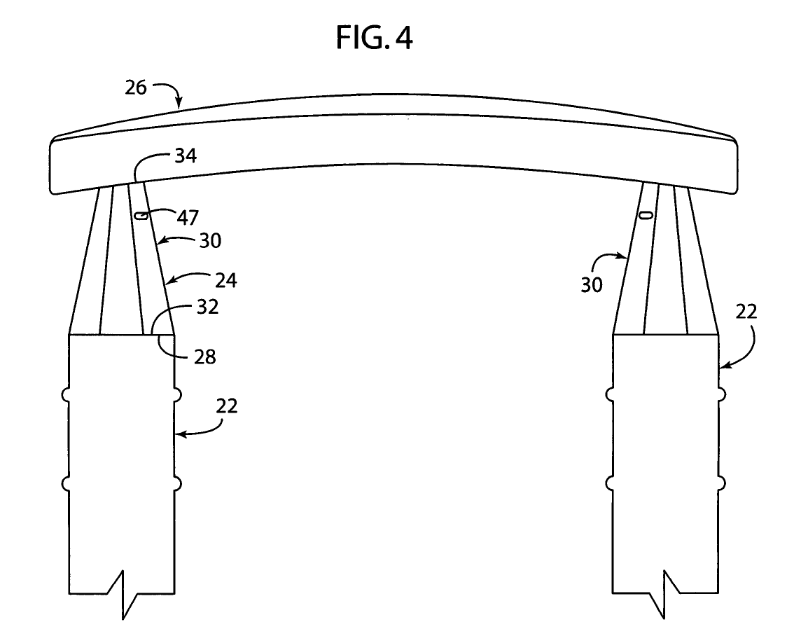

The reference number 20 (FIG. 4) generally designates a bumper system for a vehicle according to the present invention. In the illustrated example, the bumper system 20 comprises a frame rail 22, a crush member 24 and a bumper 26. The frame rail 22 extends along a longitudinal direction of the vehicle. The crush member 24 is connected to a front end 28 of the frame rail 22, with the crush member 24 comprising a tube 30 having a first end 32 connected to the frame rail 22 and a second end 34 opposite the first end 32. The tube 30 has a polygonal cross section. The tube 30 also has a constant thickness from the first end 32 to the second end 34. The tube 30 further has a taper along an axial direction from the first end 32 to the second end 34, with the tube 30 having a larger cross section at the first end 32 and a smaller cross section at the second end 34. The bumper 26 is connected to the second end 34 of the tube 30. The tube 30 is configured to crush to absorb impact energy upon an axial or near axial load applied to the bumper 26.

In the illustrated example, the bumper 26 is configured to be located at a front end or rear end of the vehicle. The bumper 26 can include an energy absorber and bumper beam. It is contemplated that any bumper 26 could be used with the present invention. Such bumpers are well known to those skilled in the art. An example of a bumper that could be used in the bumper system 20 is disclosed in U.S. Pat. No. 6,848,730 entitled BUMPER SYSTEM WITH FACE-MOUNTED ENERGY ABSORBER, the entire contents of which are hereby incorporated herein by reference. Furthermore, it is contemplated that the bumper 26 could be covered by fascia as is well known to those skilled in the art.

The illustrated tube 30 of the crush member 24 is configured to crush to absorb impact energy upon an axial or near axial load applied to the bumper 26. The crush member 24 is preferably fabricated by first roll forming a flat panel of structural or HSLA (high strength, low alloy) steel into a cylinder. The cylinder is then expanded to form the tube 30, with the tube having the constant thickness from the first end 32 to the second end 34 and having the taper along the axial direction from the first end 32 to the second end 34. Tapering the tube 30 provides better bending stiffness for near axial impacts and the taper provides predictive collapse where crush is initiated at the second end 34 (the smaller circumference end). For optimal performance during axial and near axial impacts, the first end 32 of the tube 30 is positioned rearward of the point of contact. This orientation will position the second end 34 closest to the point of impact. The tube 30 will also have the larger cross section at the first end 32 and the smaller cross section at the second end 34. Various materials and thicknesses can be selected to deliver an optimized F-d curve response.

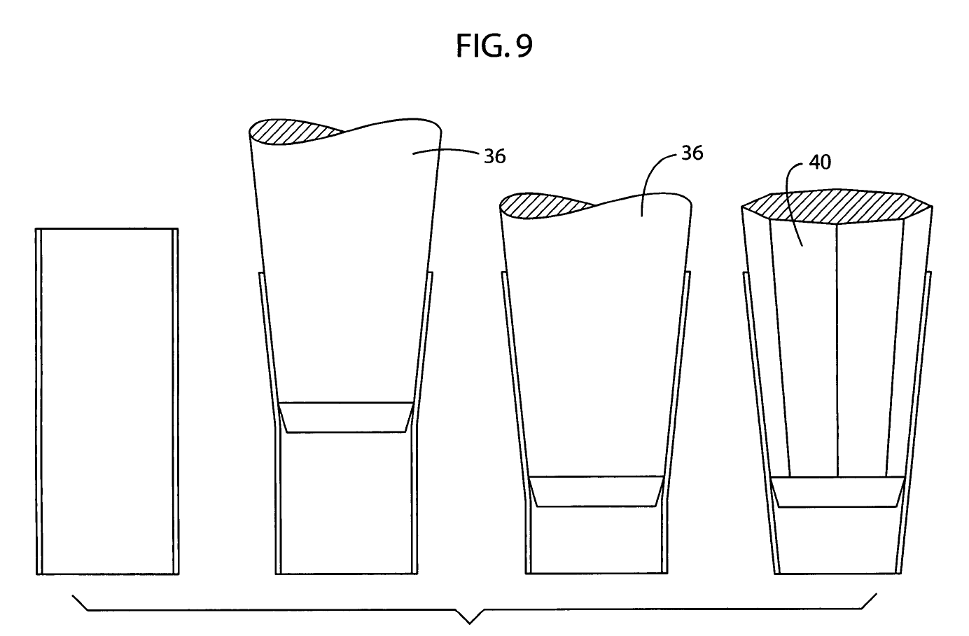

In the illustrated embodiment, the crush member 24 is formed during a two-step expansion process. A first step of forming the tube 30 comprises inserting a first mandrel 36 into the cylinder (see FIGS. 7 and 9). The first mandrel 36 preferably includes a frusto-conical outer surface 38. The first step of forming the tube 30 is preferably used to expand the cylinder into the final overall size of the first end 32 and the second end 34 of the tube 30 and to form the taper of the tube 30. The second step of forming the tube 30 comprises inserting a second mandrel 40 into the cylinder. The second mandrel 40 preferably includes an outer surface 42 having a tapered polygonal cross section. In the illustrated embodiment, the second mandrel 40 includes an octagonal cross section. However, it is contemplated that the second mandrel 40 could have any cross-sectional shape. During both the first step and the second step of forming the tube 30, the thickness of the walls of the tube 30 are not thinned. The lack of thinning is accomplished by allowing the length of the cylinder to change during the first and second step of forming the tube 30. Accordingly, the cylinder has a longer length than the tube 30 as the material used to allow the cylinder to expand is taken from the length of the cylinder. Although the illustrated method of forming the tube 30 includes two steps with two mandrels, it is contemplated that the method of forming the tube 30 could include any number of expansion stages (step(s) and mandrel(s)) based on the complexity of the final shape of the tube 30 and the materials used to form the tube 30.

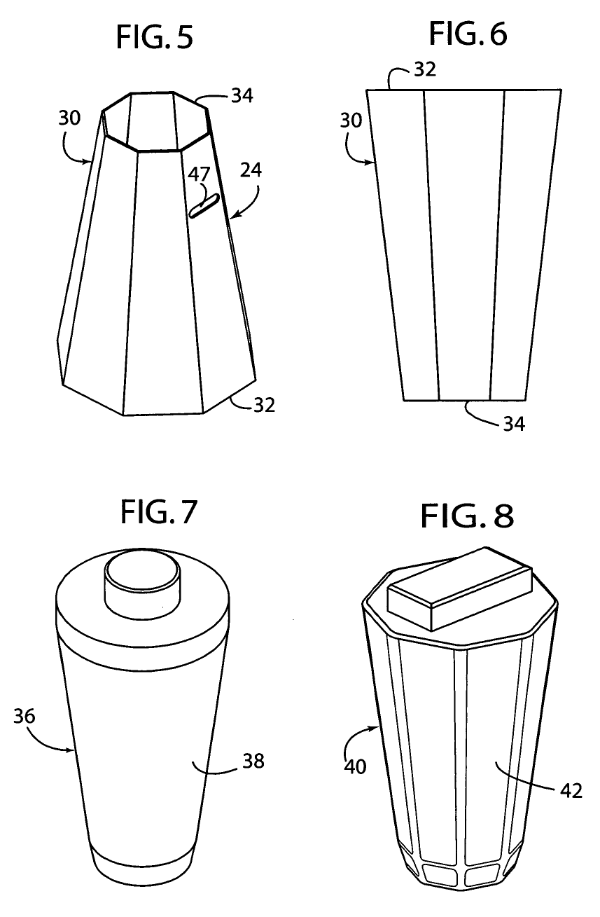

The illustrated crush member 24 of the present invention preferably includes crush initiators adjacent the second end 34 of the crush member 24 to initiate collapse of the crush member 24. FIGS. 4 and 5 illustrate a first embodiment of the crush initiators. The crush initiators in the first embodiment as illustrated in FIGS. 4 and 5 include an aperture 47 in one face of the surface of the crush member 24. Preferably, the aperture 47 is non-circular. In the illustrated embodiment, the aperture 47 is oval. However, it is contemplated that the aperture could have any shape. In the illustrated embodiment, the crush member 24 includes one aperture 47. However, it is contemplated that any number of apertures 47 could be used. Preferably, the crush member 24 with an octagonal cross section includes three apertures 47. If the crush member 24 is connected to a curved bumper 26 (as illustrated in FIG. 4), the apertures are preferably positioned on an inboard face of the crush member 24 (as substantially illustrated in FIG. 4).

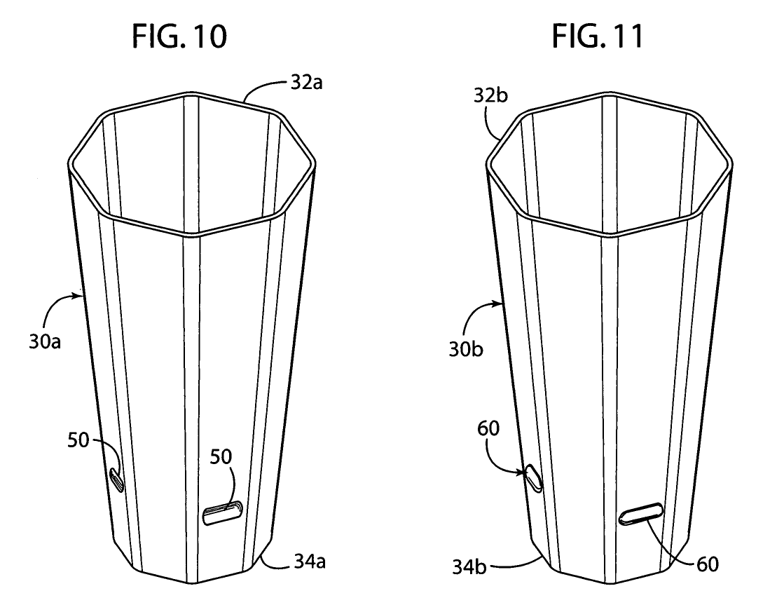

The reference numeral 30a (FIG. 10) generally designates another embodiment of the present invention, having a second embodiment for the tube. Since tube 30a is similar to the previously described tube 30, similar parts appearing in FIGS. 4-6 and FIG. 10, respectively, are represented by the same, corresponding reference number, except for the suffix “a” in the numerals of the latter. The tube 30a is identical to the first embodiment of the tube 30, except that the second embodiment of the tube 30a includes a plurality of crush initiators in the form of inwardly facing ribs 50. The ribs 50 are preferably located adjacent the second end 34a of the tube 30a. In the illustrated embodiment, the four oval ribs 50 are shown. However, it is contemplated that any number of ribs 50 having any shape could be used.

The reference numeral 30b (FIG. 11) generally designates another embodiment of the present invention, having a third embodiment for the tube. Since tube 30b is similar to the previously described tube 30, similar parts appearing in FIGS. 4-6 and FIG. 11, respectively, are represented by the same, corresponding reference number, except for the suffix “b” in the numerals of the latter. The tube 30b is identical to the first embodiment of the tube 30, except that the third embodiment of the tube 30b includes a plurality of crush initiators in the form of outwardly facing ribs 60. The ribs 60 are preferably located adjacent the second end 34b of the tube 30b. In the illustrated embodiment, the four oval ribs 60 are shown. However, it is contemplated that any number of ribs 60 having any shape could be used.

It is to be understood that variations and modifications can be made on the aforementioned structure without departing from the concepts of the present invention. Furthermore, it is to be understood that such concepts are intended to be covered by the following claims unless these claims by their language expressly state otherwise.

We claim:

1. A crush member for a vehicle having frame rails comprising:
a tube having a first end configured to be connected to the frame rails of the vehicle and a second end configured to be connected to a bumper;
the tube having a polygonal cross section;
the tube also having a constant thickness from the first end to the second end; and
the tube further having a taper along an axial direction from the first end to the second end, the tube having a larger cross section at the first end and a smaller cross section at the second end;
wherein the tube is configured to crush to absorb impact energy upon an axial or near axial load.

2. The crush member of claim 1, wherein:
the tube includes at least one crush rib adjacent the first end of the tube.

3. The crush member of claim 2, wherein:
the at least one crush rib extends outwardly from an outside surface of the tube.

4. The crush member of claim 2, wherein:
the at least one crush rib extends inwardly from an inside surface of the tube.

5. The crush member of claim 1, wherein:
the tube includes at least one aperture adjacent the first end of the tube.

6. The crush member of claim 5, wherein:
the at least one aperture is non-circular.

7. A bumper system for a vehicle comprising:
a frame rail extending along a longitudinal direction of the vehicle;
a crush member connected to a front end of the frame rail, the crush member comprising a tube having a first end connected to the frame rail and a second end opposite the first end, the tube having a polygonal cross section, the tube also having a constant thickness from the first end to the second end, and the tube further having a taper along an axial direction from the first end to the second end, the tube having a larger cross section at the first end and a smaller cross section at the second end; and
a bumper connected to the second end of the tube;
wherein the tube is configured to crush to absorb impact energy upon an axial or near axial load applied to the bumper.

8. The bumper system of claim 7, wherein:
the tube includes at least one crush rib adjacent the first end of the tube.

9. The bumper system of claim 8, wherein:
the at least one crush rib extends outwardly from an outside surface of the tube.

10. The bumper system of claim 8, wherein:
the at least one crush rib extends inwardly from an inside surface of the tube.

11. The bumper system of claim 7, wherein:
the tube includes at least one aperture adjacent the first end of the tube.

12. The bumper system of claim 11, wherein:
the at least one aperture is non-circular.

13. A method of making a crush member for a vehicle having frame rails comprising:
forming material into a cylinder;
expanding the cylinder into a tube having at least a portion with a constant thickness from a first end of the portion to a second end of the portion and to have a taper along an axial direction from the first end to the second end, with the tube having a larger cross section at the first end and a smaller cross section at the second end.

14. The method of making a crush member of claim 13, wherein:
expanding includes inserting at least one mandrel into the cylinder.

15. The method of making a crush member of claim 14, wherein:
expanding includes inserting at least two mandrels into the cylinder.

16. The method of making a crush member of claim 15, wherein:
the mandrels include a frusto-conical mandrel and a polygonal tapering mandrel.

17. The method of making a crush member of claim 16, wherein:
expanding includes inserting the frusto-conical mandrel into the cylinder first and then inserting the polygonal tapering mandrel into the cylinder to form the tube.

18. The method of making a crush member of claim 13, further including:
forming at least one crush rib adjacent the first end of the tube.

19. The method of making a crush member of claim 18, wherein:
the at least one crush rib extends outwardly from an outside surface of the tube.

20. The method of making a crush member of claim 18, wherein:
the at least one crush rib extends inwardly from an inside surface of the tube.

21. The method of making a crush member of claim 13, further including:
forming at least one aperture adjacent the first end of the tube.

22. The method of making a crush member of claim 21, wherein:
the at least one aperture is non-circular.

23. The method of making a crush member of claim 13, wherein:
the cylinder is longer in the axial direction before expanding the cylinder than after expanding the cylinder.

24. A crush member for a vehicle comprising:
a tube having a first end configured to be located adjacent a support member of the vehicle and a second end configured to be located behind an impact member;
the tube having a polygonal cross section;
the tube also having a constant thickness from the first end to the second end; and
the tube further having a taper along an axial direction from the first end to the second end, the tube having a larger cross section at the first end and a smaller cross section at the second end;
wherein the tube is configured to crush to absorb impact energy upon a load applied to the impact member.
